(19) United States
(12) Patent Application Publication
(10) Pub. No.: US 2015/0368948 A1
(43) Pub. Date: Dec. 24, 2015

(54) Device and Method For Adjusting Door Hinge

(71) Applicant: Roy Scott Ward, Lebanon, OH (US)

(72) Inventor: Roy Scott Ward, Lebanon, OH (US)

(21) Appl. No.: 14/736,620

(22) Filed: Jun. 11, 2015

Related U.S. Application Data
(60) Provisional application No. 62/014,810, filed on Jun. 20, 2014.

(51) Int. Cl. E05D 7/04; F16B 33/00

(52) U.S. Cl. CPC E05D 7/043; F16B 33/00; E05D 2007/0453; E05D 2007/0484

(57) ABSTRACT

Disclosed is a retro-fittable device and method for adjusting a hinged door. The device includes an elongated hollow base member having exterior and interior threads and an adjustment member having a threaded shank that adjustably engages the interior threads of the base member. The adjustment member includes an enlarged head portion with a tool engagement socket therein. The base member and adjustment member can be installed in a wall stud through a door jam under a hinge and in alignment with a screw hole in a leaf of the hinge. The adjustable member head portion is larger in diameter than the screw hole and the tool engagement socket is sized such that an adjustment tool can be inserted through the screw hole to adjust the adjustment member, thereby adjusting position of the door jamb relative to the stud.

### RELATED APPLICATION

This application claims the benefit of U.S. Provisional Patent Application No. 62/014,840 filed Jun. 20, 2014, the contents of while is hereby incorporated by reference.

### TECHNICAL FIELD

This invention relates to a device and method for use with standard door hinges allowing the door attached to the hinge to be adjusted relative to the door jamb or for the door jamb to be adjusted relative to the wall stud.

### BACKGROUND OF THE INVENTION

Standard interior and exterior residential doors are typically mounted in a door jamb using two or more hinges. The typical hinge has two leaves, one attached, typically by screws, to the jamb and the other to the hinged edge of the door.

Due to a variety of conditions, a door may become misaligned with the jamb. This can be caused by shifting of the wall or jamb due to shifts in the building structure itself or due to warpage of the door or jamb caused by changes in humidity and/or temperature. Adjustments changing the angle at which the door pivots on the hinge may be sufficient to correct this misalignment. Such adjustments are commonly made by inserting shims under the hinge. Adjustment this way is accomplished by trial and error, each trial requiring the hinge's leaf to be detached, shims adjusted, reattached, and testing to see if the adjustment was successful. In other situations, the door jamb has sagged relative to the wall stud. Correcting this situation would generally require removal of the door trim and driving shims between the jamb and the stud.

Various specialty hinges have been proposed that allow limited adjustment of the angle at which the hinge attaches a door jamb in order to allow adjustment to compensate for shifts in the door and/or jamb after installation. Such specialized hinges cost significantly more than ordinary hinges, making it cost prohibitive to install them on every door during initial construction, particularly when the majority of doors will never need adjustment. Alternatively, retrofitting such specialized hinges can be difficult because they do not match the style and shape of the original hinges and require routing or filling for proper installation into the door jamb and/or door edge.

The present invention provides a device that may be installed and then adjusted according to the present method without detachment of the hinge. The device may be retrofitted as needed into existing construction to allow selective adjustment and readjustment of door hinge angle and alignment.

### SUMMARY OF THE INVENTION

The present invention provides a retro-fittable device and method for adjusting a hinged door. The device includes an elongated hollow base member having exterior and interior threads and an adjustment member having a threaded shank that adjustably engages the interior threads of the base member. The adjustment member includes an enlarged head portion with a tool engagement socket therein. The base member and adjustment member can be installed in a wall stud through a door jam under a hinge and in alignment with a screw hole in a leaf of the hinge. The adjustable member head portion is larger in diameter than the screw hole and the tool engagement socket is sized such that an adjustment tool can be inserted through the screw hole to adjust the adjustment member, thereby adjusting position of the door jamb relative to the stud.

### BRIEF DESCRIPTION OF THE DRAWING

Like reference numerals are used to indicate like parts throughout the various figures of the drawing, wherein:

FIG. 1 is a plan view of the base and adjustment members according to one embodiment of the present invention;

FIG. 2 is a longitudinal sectional view thereof;

FIG. 3 is a cross-sectional view of the device installed taken substantially along line 3-3 of FIG. 4;

FIG. 4 is a plan view of the device installed; and

FIG. 5 is a cross-sectional view similar to FIG. 3 showing an alternate installation of the device and method for adjusting the door jamb relative to the wall stud.

### DETAILED DESCRIPTION OF THE INVENTION

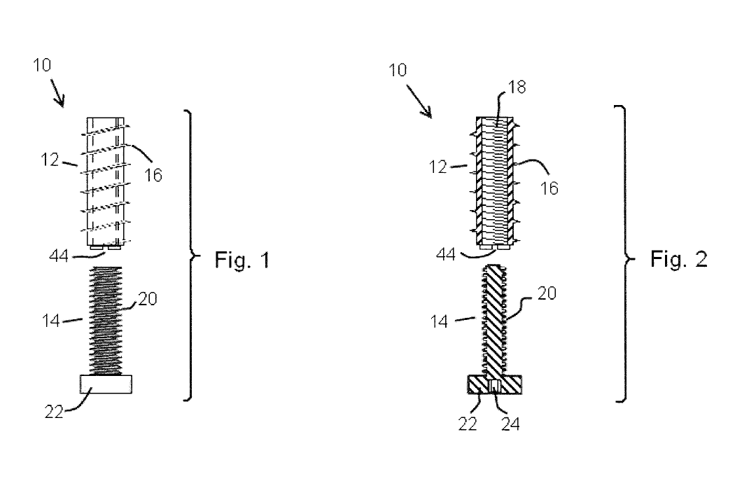

Referring to the various figures of the drawing, and first to FIGS. 1 and 2, therein is shown a device 10 that may be comprised of as few as two parts, a base member 12 and an adjustment member 14. The device 10 may be installed with minimal modification to the door jamb, using minimal tools, and by a person with minimal skills. The base member 12 may be tubular, having relatively course exterior threads 16 and relatively finer interior threads 18. The adjustment member 14 has a threaded shank 20 and an enlarged head portion 22 at one end. The head portion 22 includes a socket 24, which may accept any of a variety of well known driving engagements, such as a hex, Torx™, or slot. The threaded shank 20 has threads sized to match the interior threads 18 of the base member 12.

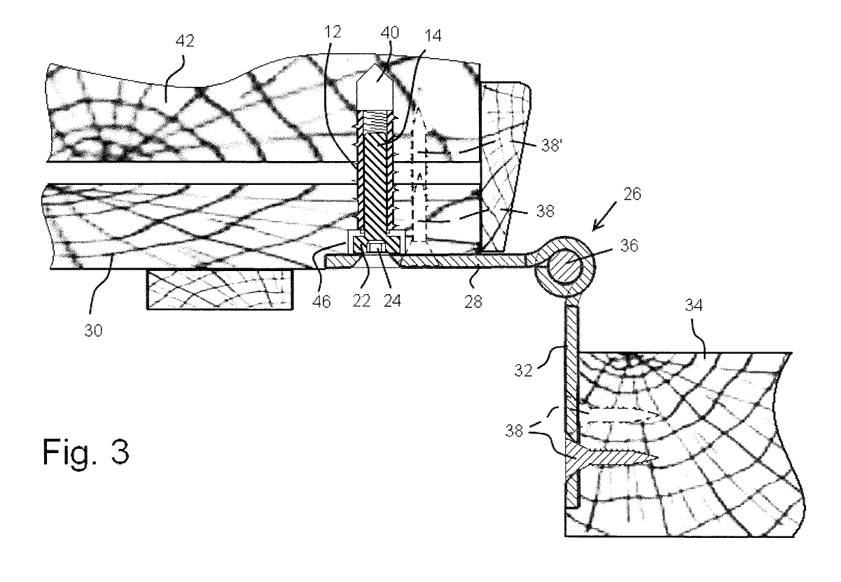

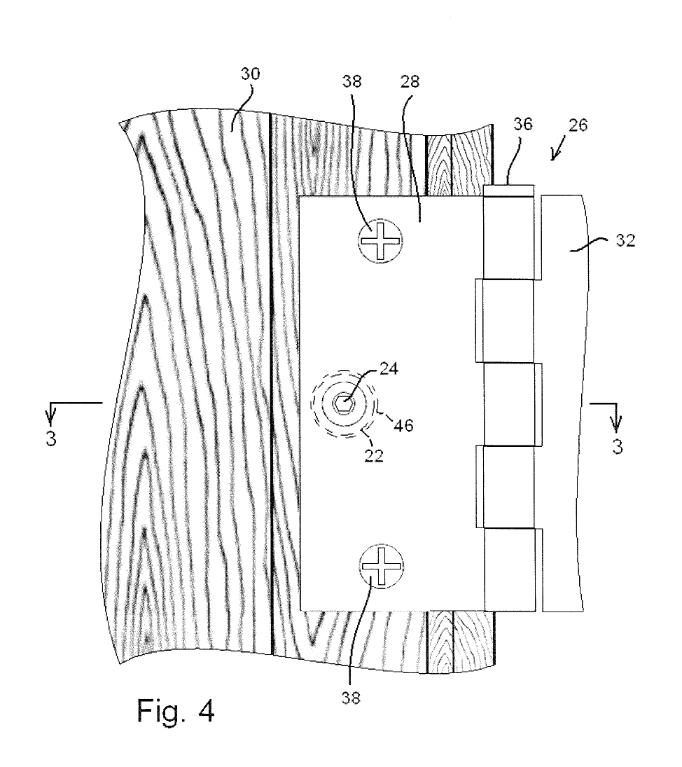

Referring now also to FIGS. 3 and 4, therein is shown at 26 a common door hinge. The hinge 26 includes a first leaf 28 that is secured to a door jamb 30 and a second leaf 32 which is secured to an edge of a door 34. The first and second hinge leaves 28, 32 are pivotally connected by and pivot on a hinge pin 36.

To install the device 10, the mounting screws 38 are removed from one leaf of the hinge 26. For example, the mounting screws 38 may be removed from the first leaf 28, freeing the leaf 28 from attachment to the door jamb 30. It is common in door hinges 26 that placement of the attachment screws 38 are staggered out of vertical alignment with at least one being spaced further from the hinge pin 36 than the others. Use of the present device 10 is typically most effective if installed in place of one of the attachment screws 38 that is more distant from the hinge pin 36.

After detachment of the hinge leaf 28, an enlarged opening 40 is drilled in alignment with the opening remaining from one of the removed attachment screws 38. This enlarged opening 40 is sized to receive the base member 12 and allow the exterior thread 16 to engage the door jamb 30 and, in some cases, the wall stud 42 (sometimes known as a jack stud or trimmer) behind the jamb 30. Either before or after the enlarged opening 40 is formed, a recess or counter sunk area 46 is provided in the door jamb 30 that is sized to completely receive the head portion 22 of the adjustment member 14.

The base member 12 may be threaded or rotatably driven into place in any of a variety of ways. For example, the adjustment member 14 or another threaded member (not shown) having a head enlarged so as not to pass into the base member 12 may be inserted and used to apply rotating force, such as with a screw driver or hexagonal wrench. Alternatively, the base member 12 may have a slotted engagement 44 at one end which allows the base member 12 to be turned with an ordinary screw driver.

Once the base member 12 is secured in place as shown in FIG. 3, the adjustment member 14 is threaded into the base member 12 until the head portion 22 is fully recessed in the counter sunk area 46. The first leaf 28 is then reattached to the door jamb 30 either using the original attachment screws 38 or oversized/over-length attachment screws 38′ to enhance the security of the attachment.

The drive socket 24 in the head portion 22 of the adjustment member 14 is then exposed through the opening in the hinge leaf 28 that previously held a mounting screw 38. A hexagonal wrench or other rotational tool may be inserted into the socket 24 in order to rotate the adjustment member 14. As the adjustment member 14 is backed out of engagement with the base member 12, force is applied to the underside of the hinge leaf 28, causing the angle at which the hinge 26 is mounted to change. Adjustments may be made to the adjustment member 14 in very fine increments and without having to detach the hinge leaf 28 from the door jamb 30 between adjustments.

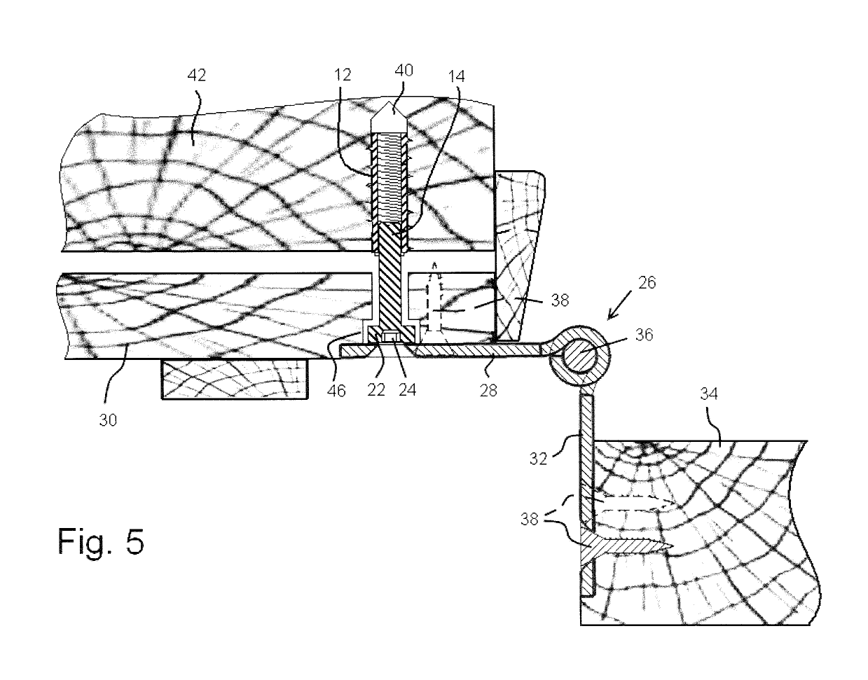

Referring now to FIG. 5, therein is shown an alternate embodiment and method for using the invention. The enlarged opening 40 may be drilled sufficiently deep into the stud 42 so that the base member 12 may be installed completely beyond the thickness of the door jamb 30.

Once the base member 12 is secured in place as shown in FIG. 5, the adjustment member 14 is threaded into the base member 12 until the head portion 22 is fully recessed in the counter sunk area 46. The first leaf 28 is then reattached to the door jamb 30 either using the original attachment screws 38 or oversized/over-length attachment screws 38′ to enhance the security of the attachment. In this case, as the adjustment member 14 is backed out of engagement with the base member 12, force is applied to the underside of the hinge leaf 28, causing the position of the jamb 30 relative to the stud 42 to change. In this manner, adjustments may be made to the adjustment member 14 in very fine increments in order to adjust the position of the door jamb 30 back into square or plumb.

While certain embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention.

What is claimed is:

1. A retro-fittable device for adjusting a hinged door, comprising:
an elongated hollow base member having exterior and interior threads; and
an adjustment member having a threaded shank that adjustably engages the interior threads of the base member and an enlarged head portion with a tool engagement socket therein,
the base member and adjustment member being installable in a wall stud through a door jam under a hinge and in alignment with a screw hole in a leaf of the hinge, the adjustment member head portion being larger in diameter than the screw hole and the tool engagement socket being sized such that an adjustment tool can be inserted through the screw hole to adjust the adjustment member, thereby adjusting position of the door jamb relative to the stud.

2. A method of adjusting a hinged door jamb relative to a wall stud, comprising:
providing an elongated hollow base member having exterior and interior threads;
providing an adjustment member having a threaded shank that adjustably engages the interior threads of the base member and an enlarged head portion with a tool engagement socket therein;
providing an enlarged installation opening through a door jamb and into a wall stud in axial alignment with a screw hole in a leaf of a door hinge
installing the base member in the wall stud through the door jam in the installation opening;
installing the adjustment member in the base member such that the enlarged head portion is behind the hinge leaf; and
adjusting the adjustment member with a tool inserted through the screw hole into the engagement socket to adjust the adjustment member, thereby adjusting position of the door jamb relative to the stud.

3. The method of claim 2, further comprising providing a recess in the door jamb to receive the enlarged head portion of the adjustment member under the hinge leaf.
